(19) United States
(12) Patent Application Publication
(10) Pub. No.: US 2023/0175611 A1
(43) Pub. Date: Jun. 8, 2023

(54) GROMMET

(71) Applicant: SUMITOMO WIRING SYSTEMS, LTD., Mie (JP)

(72) Inventors: Taiki KOBAYASHI, Mie (JP); Katsuhiko SATO, Mie (JP)

(21) Appl. No.: 17/922,308

(22) PCT Filed: May 14, 2021
(86) PCT No.: PCT/JP2021/018423

§ 371 Date: Oct. 28, 2022

(30) Foreign Application Priority Data
May 18, 2020 (JP) 2020-086710

(51) Int. Cl. F16L 5/10; H01B 17/58; F16L 5/14; B60R 16/02

(52) U.S. Cl. CPC F16L 5/10; H01B 17/583; F16L 5/14; B60R 16/0222; H02G 3/22

(57) ABSTRACT

A grommet according to an aspect of the present disclosure includes: a base part that is fixed to an insertion hole provided in a vehicle body panel; a tubular part that covers an outer circumference of a wire harness inserted into the insertion hole; and a coupling part that couples a basal portion of the tubular part and the base part while allowing tilting movement of the tubular part. The coupling part includes a compression allowance part provided on a first direction side in a circumferential direction and a tension allowance part provided on a second direction side opposite to the first direction side, such that when a leading end side of the tubular part is inclined toward the first direction side, stress applied to the base part is smaller than when the leading end side of the tubular part is inclined toward the second direction side.

### TECHNICAL FIELD

The present disclosure relates to a grommet.

### BACKGROUND

When a wire harness is inserted into an insertion hole provided in a vehicle body panel, a grommet may be used to water-seal the insertion hole. Such a grommet may be attached to a vehicle body panel using a bracket fixed to the vehicle body panel as described in Patent Document 1, for example. This grommet includes a base part that is fixed to the insertion hole provided in the vehicle body panel, a tubular part that covers the outer circumference of a wire harness, and a coupling part that couples the basal portion of the tubular part and the base part while allowing tilting movement of the tubular part through warping. When the edge portion of the base part is sandwiched between the bracket and the surrounding region of the insertion hole in the vehicle body panel, the grommet is attached to the vehicle body panel to water-seal a space between vehicle body panel and the grommet.

### PRIOR ART DOCUMENT

### Patent Document

Patent Document 1: JP 2016-210214 A

### SUMMARY OF THE INVENTION

### Problems to be Solved

In the grommet described above, the entire circumference of the coupling part is uniformly shaped. The coupling part has a protruding-recessed shape in which a protruding shape protruding from the base part toward the extending side of the tubular part and a recessed shape recessed toward the opposite side are provided continuous to each other. Accordingly, if the leading end side of the tubular part is inclined toward a first direction side in a circumferential direction, for example, the tubular part may press a portion of the protruding shape of the coupling part against the base part on the first direction side, and apply stress to the base part. This may also affect the contact portion between the grommet and the vehicle body panel and affect the water-sealing properties of the grommet. As such, there is demand for further improvement in the water-sealing properties of the grommet.

An object of the present disclosure is to provide a grommet with which water-sealing properties can be improved.

### Means to Solve the Problem

A grommet in the present disclosure is a grommet that includes: a base part that is fixed to an insertion hole provided in an attachment target; a tubular part that covers an outer circumference of a wire harness inserted into the insertion hole; and a coupling part that couples a basal portion of the tubular part and the base part while allowing tilting movement of the tubular part. The coupling part includes a compression allowance part provided on a first direction side in a circumferential direction and a tension allowance part provided on a second direction side opposite to the first direction side, such that when a leading end side of the tubular part is inclined toward the first direction side, stress applied to the base part is smaller than when the leading end side of the tubular part is inclined toward the second direction side.

### Effect of the Invention

According to the grommet of the present disclosure, it is possible to improve the water-sealing properties of the grommet.

### BRIEF DESCRIPTION OF THE DRAWINGS

FIG. 1 is a plan view of a vehicle body panel, a grommet, and a bracket in an embodiment.

FIG. 2 is a cross-sectional view taken along line 2-2 in FIG. 1.

FIG. 3 is a perspective view of the grommet.

FIG. 4 is a cross-sectional view taken along line 4-4 in FIG. 1.

### DETAILED DESCRIPTION TO EXECUTE THE INVENTION

### Description of Embodiments of Present Disclosure

First, embodiments of the present disclosure will be listed and described.

(1) grommet of the present disclosure is

a grommet that includes: a base part that is fixed to an insertion hole provided in an attachment target; a tubular part that covers an outer circumference of a wire harness inserted into the insertion hole; and a coupling part that couples a basal portion of the tubular part and the base part while allowing tilting movement of the tubular part. The coupling part includes a compression allowance part provided on a first direction side in a circumferential direction and a tension allowance part provided on a second direction side opposite to the first direction side, such that when a leading end side of the tubular part is inclined toward the first direction side, stress applied to the base part is smaller than when the leading end side of the tubular part is inclined toward the second direction side.

According to this configuration, the coupling part has the compression allowance part provided on the first direction side and the tension allowance part provided on the second direction side opposite to the first direction side. The compression allowance part and the tension allowance part are provided such that when the leading end side of the tubular part is inclined toward the first direction side, the stress applied to the base part is smaller than when the leading end side of the tubular part is inclined toward the second direction side. Accordingly, even if the leading end side of the tubular part is inclined by the wire harness toward the first direction side, the stress applied to the base part is small This suppresses the occurrence of a gap between the attachment target and the base part and improves the water-sealing properties.

[2] The tension allowance part preferably has a protruding-recessed shape in which a protruding shape protruding from the base part toward an extending side of the tubular part and a recessed shape recessed toward the opposite side are provided continuous to each other.

According to this configuration, the tension allowance part has the protruding-recessed shape in which the protruding shape protruding from the base part toward the extending side of the tubular part and the recessed shape recessed toward the opposite side are provided continuous to each other. Accordingly, when the leading end side of the tubular part is inclined toward the first direction side, the tension allowance part can easily elastically deform so as to extend, thereby reducing the stress applied to the base part. In other words, the tension allowance part has a margin for extension due to its protruding-recessed shape.

[3] The compression allowance part is preferably formed in a recessed shape that is recessed from the base part toward the side opposite to the extending side of the tubular part.

According to this configuration, the compression allowance part is formed in the recessed shape that is recessed from the base part toward the side opposite to the extending side of the tubular part, so that when the leading end side of the tubular part is inclined toward the first direction side, the compression allowance part can easily elastically deform such that the tubular portion leans, and be unlikely to come into contact with the tubular part, thereby reducing the stress applied to the base part. That is, if the compression allowance part is formed in a protruding-recessed shape, when the leading end side of the tubular part is inclined toward the first direction side, the tubular part may press the protruding shape portion against the base part and apply stress to the base part. However, this problem can be avoided and the and the stress applied to the base part can be reduced. In other words, the compression allowance part is provided with an interference prevention space utilizing its recessed shape.

[4] Under no external force, the tubular part preferably extends in a direction orthogonal to a flat surface of the base part.

According to this configuration, the tubular part under no external force extends in the direction orthogonal to the flat surface of the base part, so as to facilitate mold of the tubular part compared to a case in which the tubular part is extended in advance at an incline with respect to the flat surface of the base part, for example. The grommet can be easily molded using a pair of vertical molds, for example.

[5] The tubular part is a first tubular part, and the grommet (20) preferably further includes a second tubular part (22). The first direction is preferably set to a direction orthogonal to a direction of parallel arrangement of the first and second tubular parts.

According to this configuration, the first direction is set to the direction orthogonal to the direction of parallel arrangement of the first and second tubular parts, so that even if the leading end side of the tubular part is inclined toward the first direction side, the tubular parts do not come into contact with each other. This makes it possible to prevent an increase in the stress applied to the base part that could be caused by contact between the tubular parts.

### Details of Embodiments of Present Disclosure

Specific examples of the grommet according to the present disclosure will be described below with reference to the drawings. It should be noted that the present invention is not limited to the examples herein, but rather is indicated by the scope of the claims, and is intended to include all modifications within a meaning and scope equivalent to the scope of claims.

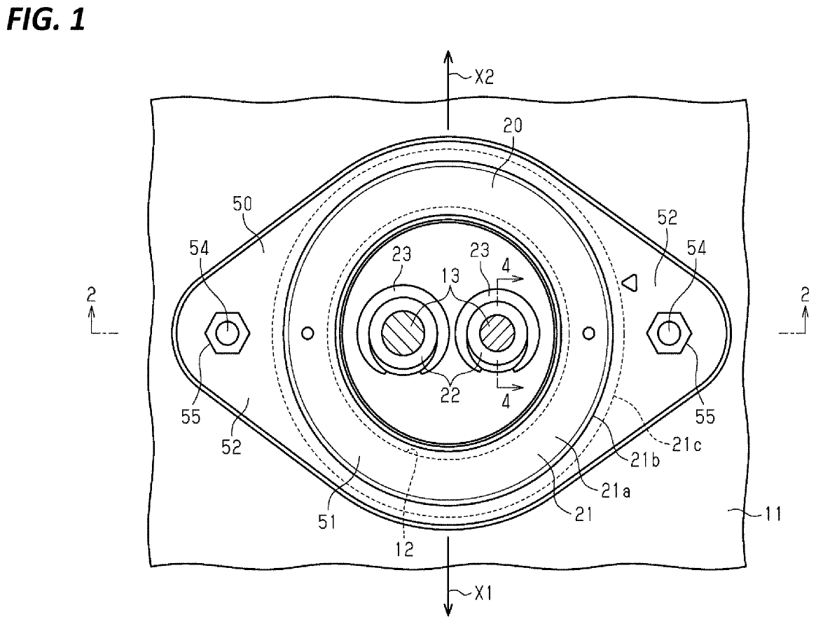

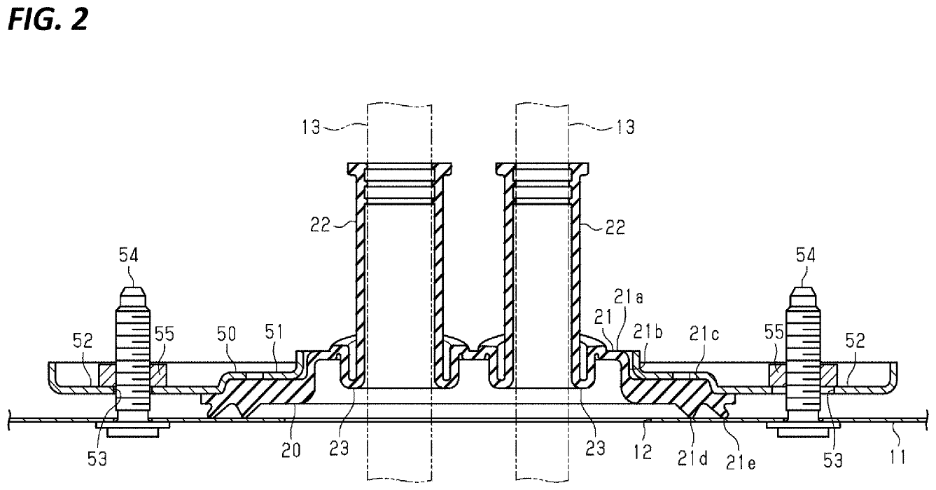

As shown in FIGS. 1 and 2, a vehicle includes a vehicle body panel 11 to which a grommet is to be attached, the vehicle body panel 11 separating the inside and outside of the vehicle. The vehicle body panel 11 is a panel that divides the under-floor space and the engine room in the vehicle, for example.

As shown in FIG. 2, the vehicle body panel 11 is provided with an insertion hole 12 that extends through the vehicle body panel 11. A wire harness 13 is inserted into the insertion hole 12. A grommet 20 is attached to the vehicle body panel 11 at a portion corresponding to the insertion hole 12. The grommet 20 is for water-sealing the insertion hole 12. That is, the grommet 20 is for water-sealing a space between the circumferential portion of the insertion hole 12 in the vehicle body panel 11 and the wire harness 13. The grommet 20 also fulfills the role of protecting the wire harness 13 inserted into the insertion hole 12.

[Configuration of Grommet 20]

The grommet 20 includes: a base part 21 that is fixed to the vehicle body panel 11 at a portion corresponding to the insertion hole 12 provided in the vehicle body panel 11; one or more tubular parts 22 that cover the outer circumference of each wire harness 13 inserted into the insertion hole 12; and a coupling part 23 that couples a basal portion of the tubular part 22 and the base part 21 while allowing tilting movement of the tubular part 22. The grommet 20 is made of a flexible material. The material for the grommet 20 may be a highly flexible elastomer such as ethylene-propylene-diene rubber (EPDM). The base part 21, the tubular part 22, and the coupling part 23 are integrally molded parts.

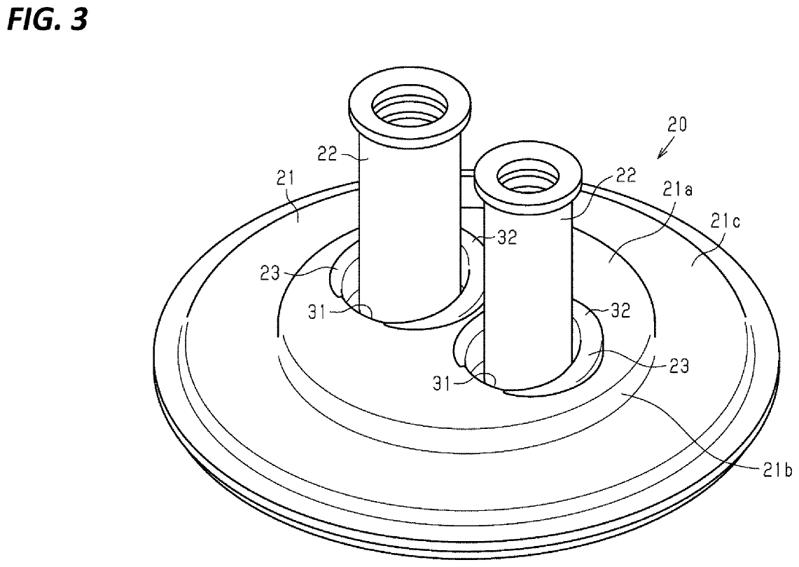

As shown in FIGS. 1 to 3, the base part 21 has a substantially disc-shaped central basal portion 21a, a step portion 21b that slightly extends in an axial direction from the outer edge of the central basal portion 21a, and an outer extension fixing portion 21c that extends radially outward from the leading end of the step portion 21b. The thickness of the outer extension fixing portion 21c is set to be larger than the thickness of the central basal portion 21a. As shown in FIG. 2, the outer extension fixing portion 21c has, on a surface facing the vehicle body panel 11, annular seal portions 21d and 21e that come into close contact with the surrounding region of the insertion hole 12 in the vehicle body panel 11 when the grommet 20 is fixed to the vehicle body panel 11. In the present embodiment, the seal portions 21d and 21e have different diameters.

Under no external force, the tubular part 22 extends in a direction orthogonal to the flat surface of the base part 21. In other words, under no external force, the tubular part 22 extends in the thickness direction of the base part 21. The tubular part 22 extends toward the side opposite to the side to which the step portion 21b extends. The grommet 20 may have first and second tubular parts 22. The first tubular part 22 and the second tubular part 22 in the present embodiment differ slightly in diameter, but are described with the same reference sign.

When the tubular part 22 is subjected to an external force, and a coupling part couples the basal portion of the tubular part 22 and the base part 21 while allowing tilting movement of the tubular part 22 through warping.

[Configuration of Bracket 50]

As shown in FIGS. 1 and 2, the grommet 20 is attached to the vehicle body panel 11 via a bracket 50 fixed to the vehicle body panel 11.

The bracket 50 is formed using a metallic plate member. The bracket 50 has a circular sandwiching part 51 that comes into surface contact with the outer extension fixing portion 21c of the base part 21 in the thickness direction, and one or more fixing parts 52 that extend radially outward from a portion of the outer edge of the sandwiching part 51. The grommet 20 in the present embodiment has two fixing parts 52 that are spaced 180° from each other. As shown in FIG. 2, each of the fixing parts 52 has a fixing hole 53 that extends through the fixing part 52. The fixing parts 52 of the bracket 50 are fixed to the vehicle body panel 11 via bolts 54. Each of the bolts 54 is fixed to the vehicle body panel 11, with its head welded or the like or with its shaft part extending through the vehicle body panel 11. The bracket 50 is positioned such that the sandwiching part 51 and the vehicle body panel 11 sandwich the outer extension fixing portion 21c of the grommet 20 therebetween. When nuts 55 are screwed onto the bolts 54 inserted into the fixing holes 53, the bracket 50 itself is fixed to the vehicle body panel 11 and also fixes the grommet 20 to the vehicle body panel 11. The seal portions 21d and 21 of the grommet 20 fixed in this manner are in close contact with the vehicle body panel 11. FIG. 2 shows a state where the seal portions 21d and 21e are not yet strongly pressed against the vehicle body panel 11 and the nuts 55 are not yet firmly fastened.

[Details of Coupling Part 23 of Grommet 20]

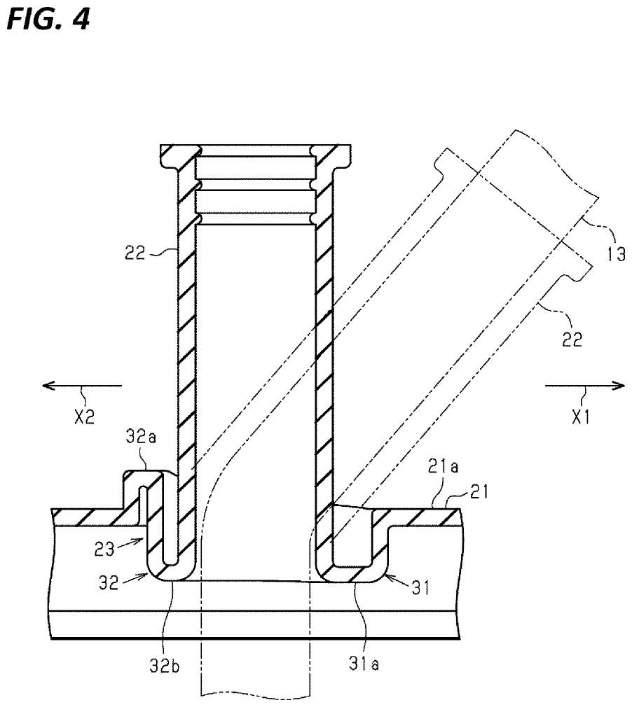

As shown in FIG. 4, the coupling part 23 has a compression allowance part 31 and a tension allowance part 32. More specifically, the coupling part 23 has the compression allowance part 31 provided on a first direction X1 side and the tension allowance part 32 provided on a second direction X2 side, such that when the leading end side of the tubular part 22 is inclined toward the first direction X1 side, the stress applied to the base part 21 is smaller than when the leading end side of the tubular part 22 is inclined toward the second direction X2 side opposite to the first direction X1 side.

Specifically, first, the grommet 20 in the present embodiment is designed on the assumption that the wire harness 13 protruding from the tubular part 22 is to be pulled out toward the first direction X1 side (see double dot-dash lines in FIG. 4).

The tension allowance part 32 is formed in a protruding-recessed shape in which a protruding portion protruding from the base part 21 toward the extending side of the tubular part 22 (upper side in FIG. 4) and a recessed portion recessed toward the opposite side are provided continuous to each other. More specifically, the tension allowance part 32 in the present embodiment has a protruding portion 32a that extends from the central basal portion 21a of the base part 21 toward the extending side of the tubular part 22 and further extends toward the axial center of the tubular part 22, and has a recessed portion 32b that extends from the leading end of the convex portion 32a toward the side opposite to the extending side of the tubular part 22, further extends toward the axial center of the tubular part 22, and is coupled to the basal portion of the tubular part 22. With this structure, when the leading end side of the tubular part 22 is inclined toward the first direction X1 side, the tension allowance part 32 can easily elastically deform so as to extend. The protruding portion 32a of the tension allowance part 32 of the present embodiment is formed so as to be highest on the second direction X2 side and gradually decrease in height in two circumferential directions of the tubular part 22.

The compression allowance part 31 is formed in a recessed shape that is recessed from the base part 21 toward the side opposite to the extending side of the tubular part 22. More specifically, the compression allowance part 31 in the present embodiment has a recessed portion 31a that extends from the central basal portion 21a of the base part 21 toward the side opposite to the extending direction of the tubular part 22, further extends toward the axial center of the tubular part 22, and is coupled to the basal portion of the tubular part 22. With this structure of the compression allowance part 31, when the leading end side of the tubular part 22 is inclined toward the first direction X1 side, the compression allowance part 31 can easily elastically deform such that the tubular portions 22 leans. In addition, due to the absence of a protruding portion, no contact occurs between the tubular part 22 and a protruding portion, and it is possible to secure a space where the tubular part 22 does not come into contact with the base part 21.

As shown in FIG. 1, the first direction X1 is set to be orthogonal to the direction of parallel arrangement of the first and second tubular parts 22 (the horizontal direction in FIG. 1).

Operation of the present embodiment will be described.

The seal portions 21d and 21e are in close contact with the surrounding region of the insertion hole 12 in the vehicle body panel 11 and suppress the passage of a liquid such as water between the circumferential portion of the insertion hole 12 in the vehicle body panel 11 and the grommet 20.

As shown in FIG. 4, when the wire harness 13 protruding from the tubular part 22 is pulled out toward the first direction X1 side, the coupling part 23 warps while the leading end side of the tubular part 22 is inclined toward the first direction X1 side. A state where the wire harness 13 is bent at a sharp angle is avoided and the wire harness 13 can be smoothly pulled out toward the first direction X1 side.

Next, advantageous effects of the foregoing embodiment will be described below.

(1) The coupling part 23 has the compression allowance part 31 provided on the first direction X1 side and the tension allowance part 32 provided on the second direction X2 side opposite to the first direction X1 side. The compression allowance part 31 and the tension allowance part 32 are provided such that, when the leading end side of the tubular part 22 is inclined toward the first direction X1 side, the stress applied to the base part 21 is smaller than when the leading end side of the tubular part 22 is inclined toward the second direction X2 side. Accordingly, even if the leading end side of the tubular part 22 is inclined toward the first direction X1 side by the wire harness 13, the stress applied to the base part 21 is small. This suppresses the occurrence of a gap between the vehicle body panel 11 and the base part 21, specifically, between the vehicle body panel 11 and the seal portions 21d and 21e provided on the base part 21, thereby improving the water-sealing properties.

(2) The tension allowance part 32 is formed in the protruding-recessed shape in which the protruding shape protruding from the base part 21 toward the extending side of the tubular part 22 and the recessed portion recessed toward the opposite side are provided continuous to each other. Accordingly, when the leading end side of the tubular part 22 is inclined toward the first direction X1 side, the tension allowance part 32 can easily elastically deform so as to extend, thereby reducing the stress applied to the base part 21.

(3) The compression allowance part 31 is formed in a recessed shape that is recessed from the base part 21 toward the side opposite to the extending side of the tubular part 22. Thus, when the leading end side of the tubular part 22 is inclined toward the first direction X1 side, the compression allowance part 31 can easily elastically deform such that the tubular part 22 leans, and the tubular part 22 is unlikely to come into contact with the base part 21, thereby reducing the stress applied to the base part 21. That is, if the compression allowance part 31 is formed in a protruding-recessed shape, for example, when the leading end side of the tubular part 22 is inclined toward the first direction X1 side, the tubular part 22 may press the protruding shape portion against the base part 21 and apply stress to the base part 21. However, this problem can be avoided and the stress applied to the base part 21 can be reduced. In addition, since the compression allowance part 31 does not have a protruding portion, it is possible to secure a large space where the tubular part 22 does not come into contact with the base part 21 even when the tubular part 22 is inclined, and keep the tubular part 22 from pressing against the base part 21, thereby reducing the stress applied to the base part 21.

(4) Under no external force, the tubular part 22 extends in a direction orthogonal to the flat surface of the base part 21. This facilitates molding of the tubular part 22 as compared to the case in which the tubular part 22 is extended in advance at an incline with respect to the flat surface of the base part 21, for example. The grommet 20 can be easily molded using a pair of vertical molds, for example.

(5) The grommet 20 has the first and second tubular parts 22, and the first direction X1 is set to be orthogonal to the direction of parallel arrangement of the first and second tubular parts 22. Thus, even if the leading end side of a tubular part 22 is inclined toward the first direction X1 side, the tubular parts 22 do not come into contact with each other. This makes it possible to prevent an increase in the stress applied to the base part 21 that could be caused by contact between the tubular parts 22.

The present embodiment can be modified as described below. The present embodiment and the following modification examples can combined and implemented provided no technical contradiction arises.

In the foregoing embodiment, while the compression allowance part 31 is formed in a recessed shape and the tension allowance part 32 is formed in a protruding-recessed shape, the shapes thereof may be changed to other shapes. That is, the shapes of the compression allowance part 31 and the tension allowance part 32 may be changed to other shapes as long as they are formed in different shapes such that, when the leading end side of the tubular part 22 is inclined toward the first direction X1 side, the stress applied to the base part 21 is smaller than when the leading end side of the tubular part 22 is inclined toward the second direction X2 side.

In the foregoing embodiment, under no external force, the tubular part 22 extends in the direction orthogonal to the flat surface of the base part 21. However, the present invention is not limited to this structure. Under no external force, the tubular part 22 may extend at an incline of an angle other than 90° with respect to the flat surface of the base part 21.

In the foregoing embodiment, the grommet 20 has two tubular parts 22, and the first direction X1 is set to a direction orthogonal to the direction of parallel arrangement of the two tubular parts 22. However, the present invention is not limited to this. For example, the grommet 20 may have only one tubular part 22. Also, for example, the first direction X1 may not be set to a direction orthogonal to the direction of parallel arrangement of the two tubular parts 22, that is, the first direction X1 may be inclined with respect to a direction orthogonal to the direction of parallel arrangement of the two tubular parts 22.

In the foregoing embodiment, the grommet 20 is fixed to the vehicle body panel 11 by the bracket 50. However, the present invention is not limited to this. The grommet 20 may be fixed to the vehicle body panel 11 without using the bracket 50. For example, the grommet 20 may have a fitting part at the outer edge of the base part 21 that is fitted and fixed to the edge of the insertion hole 12 in the vehicle body panel 11.

The present disclosure includes the following aspects. Reference signs used for some components in the foregoing exemplary embodiment are given in the following description for ease of understanding and are not to be construed as limiting. Some of the matters in the following aspects may be omitted, and some of the matters in the following aspects may be selected or extracted and combined.

[Supplementary Note 1] Some aspects of the present disclosure relate to a grommet (20) including:

a base (base part 21) that covers an opening edge of a through hole (insertion hole 12) included in an attachment target (11);

a tubular part (22) that extends so as to let a wire harness (13) pass through the through hole (12) and the tubular part; and

an annular flexible part (coupling part 23) that couples the tubular part (22) and the base part,

wherein the flexible part (23) includes:
a valley-folded recessed part (compression allowance part 31) that surrounds the entire circumference of the tubular part (22); and
a mountain-folded recessed part (tension allowance part 32) that protrudes between the valley-folded concave part (31) and the base (21) in a direction opposite to the valley-folded recessed part (31), and

the valley-folded recessed part (31) has an arc-shaped outer edge directly connected to the base (21).

[Supplementary Note 2] In some examples, the mountain-folded recessed part (32) may extend in an arc along the valley-folded recessed part (31).

[Supplementary Note 3] In some examples, the mountain-folded recessed part (32) may have an arc-shaped inner peripheral edge connected to the valley-folded recessed part (31) and an arc-shaped outer peripheral edge connected to the base (21), and two ends of the arc-shaped inner peripheral edge may be connected to two ends of the arc-shaped outer peripheral edge, respectively.

[Supplementary Note 4] In some examples, the arc-shaped inner peripheral edge or the arc-shaped outer peripheral edge may have an arc shape with a central angle of 270° or more.

[Supplementary Note 5] In some examples, the mountain-folded recessed part (32) may have a protruding height that continuously increases from two ends thereof toward a center in a circumferential direction.

[Supplementary Note 6] In some examples, the flexible part (23) may be a bellows.

[Supplementary Note 7] In some examples, the central angle of the arc-shaped outer edge may be smaller than 90°.

[Supplementary Note 8] In some examples, the valley-folded recessed part (31) may have a radial width that continuously narrows from the arc-shaped outer edge toward the center in the circumferential direction.

[Supplementary Note 9] Some aspects of the present disclosure relate to a grommet (20) including:

a base (base part 21) that covers an opening edge of a through hole (insertion hole 12) included in an attachment target (11);

a plurality of tubular parts (22) that are aligned in a transverse direction that traverses the through hole (12) and have an axial line that intersects the transverse direction; and

a plurality of annular flexible parts (coupling parts 23), each of the annular flexible parts (coupling parts 23) coupling the corresponding tubular part (22) and the base part,

wherein each of the flexible parts (23) includes:
a valley-folded recessed part (compression allowance part 31) that surrounds the entire periphery of the corresponding tubular part (22); and
a mountain-folded recessed part (tension allowance part 32) that protrudes between the valley-folded recessed part (31) and the base (21) in a direction opposite to the valley-folded recessed part (31),

the valley-folded recessed part (31) has an arc-shaped outer edge directly connected to the base (21), and

the plurality of flexible parts (23) each have the arc-shaped outer edges at the same position in the circumferential direction.

[Supplementary Note 10] In some examples, the plurality of arc-shaped outer edges may be aligned along the transverse direction.

### LIST OF REFERENCE NUMERALS

11 Vehicle body panel (attachment target)
12 Insertion hole
13 Wire harness
20 Grommet
21 Base part
21a Central basal portion
21b Step portion
21c Outer extension fixing portion
21d Seal portion
21e Seal portion
22 Tubular part
23 Coupling part
31 Compression allowance part
31a Recessed portion (recessed shape)
32 Tension allowance part
32a Protruding portion (protruding shape)
32b Recessed portion (recessed shape)
50 Bracket
51 Sandwiching part
52 Fixing part
53 Fixing hole
54 Bolt
55 Nut

1. A grommet comprising:
a base part that is fixed to an insertion hole provided in an attachment target;
a tubular part that covers an outer circumference of a wire harness inserted into the insertion hole; and
a coupling part that couples a basal portion of the tubular part and the base part while allowing tilting movement of the tubular part,
wherein the coupling part includes a compression allowance part provided on a first direction side in a circumferential direction and a tension allowance part provided on a second direction side opposite to the first direction side, such that when a leading end side of the tubular part is inclined toward the first direction side, stress applied to the base part is smaller than when the leading end side of the tubular part is inclined toward the second direction side.

2. The grommet according to claim 1,
wherein the tension allowance part has a protruding-recessed shape in which a protruding shape protruding from the base part toward an extending side of the tubular part and a recessed shape recessed toward the opposite side are provided continuous to each other.

3. The grommet according to claim 1,
wherein the compression allowance part is formed in a recessed shape that is recessed from the base part toward the side opposite to the extending side of the tubular part.

4. The grommet according to claim 1,
wherein, under no external force, the tubular part extends in a direction orthogonal to a flat surface of the base part.

5. The grommet according to claim 1,
wherein the tubular part is a first tubular part,
the grommet further comprises a second tubular part, and
the first direction is set to a direction orthogonal to a direction of parallel arrangement of the first and second tubular parts.
